(19) United States
(12) Patent Application Publication
(10) Pub. No.: US 2013/0148028 A1
(43) Pub. Date: Jun. 13, 2013

(54) DYNAMIC HYBRID BROADCASTING METHOD AND APPARATUS FOR REDUCING POOR RECEPTION AREA OF WIRELESS DIGITAL BROADCASTING SIGNAL

(71) Applicant: Electronics and Telecommunications Research Institute, Daejeon (KR)

(72) Inventors: Young Kwon HAHM, Daejeon (KR); Dong Joon CHOI, Daejeon (KR); Nam Ho HUR, Daejeon (KR)

(73) Assignee: Electronics and Telecommunications Research Institute, Daejeon (KR)

(21) Appl. No.: 13/711,574

(22) Filed: Dec. 11, 2012

(30) Foreign Application Priority Data
Dec. 12, 2011 (KR) 10-2011-0132591

(51) Int. Cl. H04N 5/44

(52) U.S. Cl. CPC H04N 5/44
USPC 348/706

(57) ABSTRACT

Provided is a broadcasting receiver including a broadcasting signal receiving unit to receive a broadcasting signal via a broadcasting network, a viewing possibility determining unit to determine whether it is possible for a viewer to view the broadcasting signal, a multicasting signal receiving unit to receive a multicasting signal via a wireless communication network, a switching and combining unit to combine or switch the received broadcasting signal and the multicasting signal, and a controlling unit to request the multicasting signal transmitting unit to multicast the multicasting signal based on the determination result, to request the multicasting signal receiving unit to receive the multicasting signal, and to control the switching and combining unit depending on whether the multicasting signal is received.

### CROSS-REFERENCE TO RELATED APPLICATION

This application claims the priority benefit of Korean Patent Application No. 10-2011-0132591, filed on Dec. 12, 2011, in the Korean Intellectual Property Office, the disclosure of which is incorporated herein by reference.

### BACKGROUND

1. Field of the Invention

The present invention relates to a dynamic hybrid broadcasting viewing device for receiving a seamless broadcast in conjunction with a wireless communication network such as a wireless local area network (LAN), a mobile communication network, and the like despite a broadcasting receiver being located in an area of poor reception while receiving a digital broadcast.

2. Description of the Related Art

An existence of poor reception area is inevitable in a field of wireless digital broadcasting, and a conventional method of remedying such a situation is to install a repeater. Since installing a great number of repeaters is required to reduce an occurrence of poor reception areas, such a method is not deemed cost effective.

Furthermore, depending on a broadcasting network environment, the installing of the repeaters may cause interference in an area of good reception area, and thereby degrade a quality of reception.

As a solution to the aforementioned issue, a hybrid broadcasting viewing device connected to a broadcasting communication network that enables a seamless broadcasting reception in conjunction with a wireless communication network having fewer of the poor reception areas is suggested herein.

### SUMMARY

An aspect of the present invention provides a method of utilizing a wireless communication network such as a wireless local area network (LAN), a mobile communication network, and the like in order to continuously receive a broadcasting signal despite a broadcasting receiver being located in a poor reception area while receiving the broadcasting signal via a broadcasting network.

Another aspect of the present invention also provides a technology of transmitting/receiving a multicasting signal, using an infrastructure of the wireless communication network in the poor reception area, and of efficiently using a multicasting function, thereby reducing resources of the wireless communication network when a number of users are simultaneously connected.

According to an aspect of the present invention, there is provided a broadcasting receiver including a broadcasting signal receiving unit to receive a broadcasting signal via a broadcasting network, a viewing possibility determining unit to determine whether it is possible for a viewer to view the broadcasting signal, a multicasting signal receiving unit to receive a multicasting signal via a wireless communication network, a switching and combining unit to combine or switch the received broadcasting signal and the received multicasting signal, and a controlling unit to request a multicasting signal transmitting unit to multicast the received multicasting signal based on the determination result, to request the multicasting signal receiving unit to receive the multicasting signal, and to control the switching and combining unit depending on whether the multicasting signal is received.

The viewing possibility determining unit may determine whether it is possible for the viewer to view the broadcasting signal based on a quality of the received broadcasting signal.

The controlling unit, when it is impossible for the viewer to view the received broadcasting signal, may request the multicasting signal transmitting unit to multicast the multicasting signal, request the multicasting signal receiving unit to receive the multicasting signal, and control the switching and combining unit based on whether the multicasting signal is received.

The broadcasting receiver may further include a display to display an output of the switching and combining unit.

The controlling unit may identify a type of the received broadcasting signal, and request the multicasting signal transmitting unit to multicast the multicasting signal corresponding to the type of the broadcasting signal.

When the controlling unit transitions to a state of being possible for the viewer to view the broadcasting signal from a state of being impossible for the viewer to view the broadcasting signal, the controlling unit may request the multicasting signal transmitting unit to suspend multicasting the multicasting signal.

The viewing possibility determining unit may determine whether it is possible for the viewer to view the broadcasting signal based on pre-stored map data and a location of the broadcasting receiver.

The controlling unit may request in advance the multicasting signal transmitting unit to multicast the multicasting signal based on a future location of the broadcasting receiver.

According to another aspect of the present invention, there is provided a method of receiving a broadcasting signal including receiving a broadcasting signal via a broadcasting network, determining whether it is possible for a viewer to view the received broadcasting signal, requesting a multicasting signal transmitting unit to multicast a multicasting signal based on the determination result, multicasting to receive the multicasting signal via a wireless communication network, and combining or switching the received broadcasting signal and the multicasting signal depending on whether the multicasting signal is received.

The determining may include determining whether it is possible for the viewer to view the received broadcasting signal based on a quality of the received broadcasting signal.

The method of receiving a broadcasting signal may further include requesting the multicasting signal transmitting unit to suspend multicasting of the multicasting signal, when the multicasting signal transmitting unit transitions to a state of being possible for the viewer to view the broadcasting signal from a state of being impossible for the viewer to view the broadcasting signal.

The method of receiving a broadcasting signal may further include identifying a type of the broadcasting signal, wherein the requesting comprises requesting the multicasting signal transmitting unit to multicast a multicasting signal corresponding to the type of the broadcasting signal.

According to still another aspect of the present invention, there is provided a method of multicasting a multicasting signal corresponding to a broadcasting signal via a wireless communication network including receiving a multicast request from at least one broadcasting receiver equipped to receive a signal via a broadcasting network and the wireless communication network, identifying the multicasting signal corresponding to the broadcasting signal received by the at least one broadcasting receiver via the broadcasting network in response to the multicast request, multicasting the multicast signal to the at least one broadcasting receiver, monitoring whether all the broadcasting receivers request the multicasting signal transmitting unit to suspend multicasting the multicasting signal, and suspending multicasting the multicasting signal when all the broadcasting receivers request the multicasting signal transmitting unit to suspend multicasting the multicasting signal.

The multicasting may include multicasting the multicasting signal using identical logical wireless resources.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating a digital broadcasting system according to a conventional art;

FIG. 2 is a diagram illustrating a broadcasting network and a wireless communication network of a digital broadcasting system according to an exemplary embodiment of the present invention;

FIG. 3 is a diagram illustrating a broadcasting system according to an exemplary embodiment of the present invention;

FIG. 4 is a flowchart illustrating an operational method of a controlling unit according to an exemplary embodiment of the present invention; and

FIG. 5 is a flowchart illustrating an operational method of a multicasting signal transmitting unit according to an exemplary embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

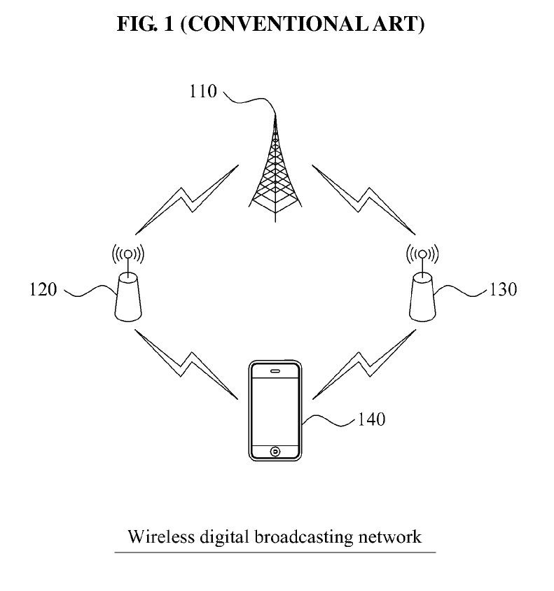

FIG. 1 is a diagram illustrating a digital broadcasting system according to invention conventional art.

Referring to FIG. 1, the digital broadcasting system includes a broadcasting base station 110, broadcasting repeaters 120 and 130, a user terminal 140 such as a digital television (TV), a smart phone, and the like.

A program provider of a digital broadcasting transmits a broadcasting signal to the user terminal 140 via the broadcasting base station 110. Here, as described above, poor reception areas may exist. To reduce a number of existing poor reception areas, the broadcasting repeaters 120 and 130 may be used.

Increasing a number of the broadcasting repeaters 120, 130 to a number greater than required may bring about an issue of interference in an area of good reception and require a high cost.

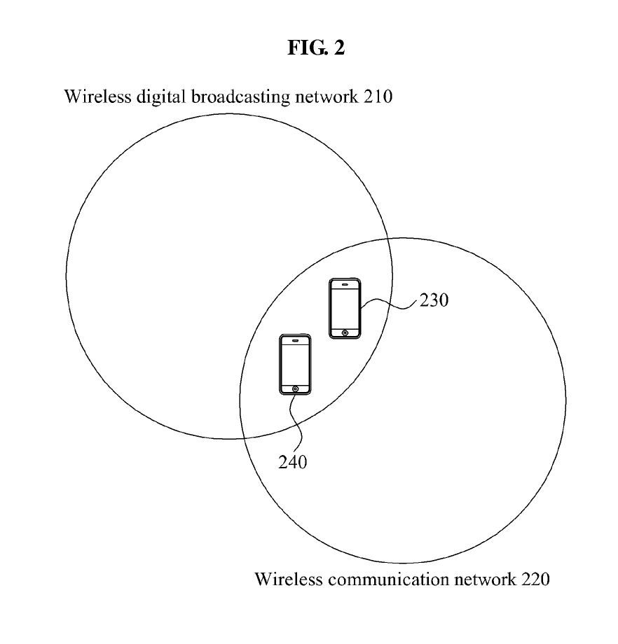

FIG. 2 is a diagram illustrating a broadcasting network of a digital broadcasting system and a wireless communication network according to an exemplary embodiment of the present invention.

Referring to FIG. 2, since a wireless digital broadcasting network 210 and a wireless communication network 220 are mutually independent, user terminals 230 and 240 may be included repeatedly in the wireless digital broadcasting network 210 and the wireless communication network 220. Here, the wireless communication network 220 may include a cellular network, a local area communication network, an ad-hoc network, and the like.

As will be described in detail hereinafter, to resolve an issue of a poor reception area present in the wireless digital broadcasting network 210, the wireless communication network 220 may be used. In particular, the present invention is directed to providing a solution to reduce poor reception areas present in the wireless communication network 220, while minimizing an overhead occurring in the wireless communication network 220.

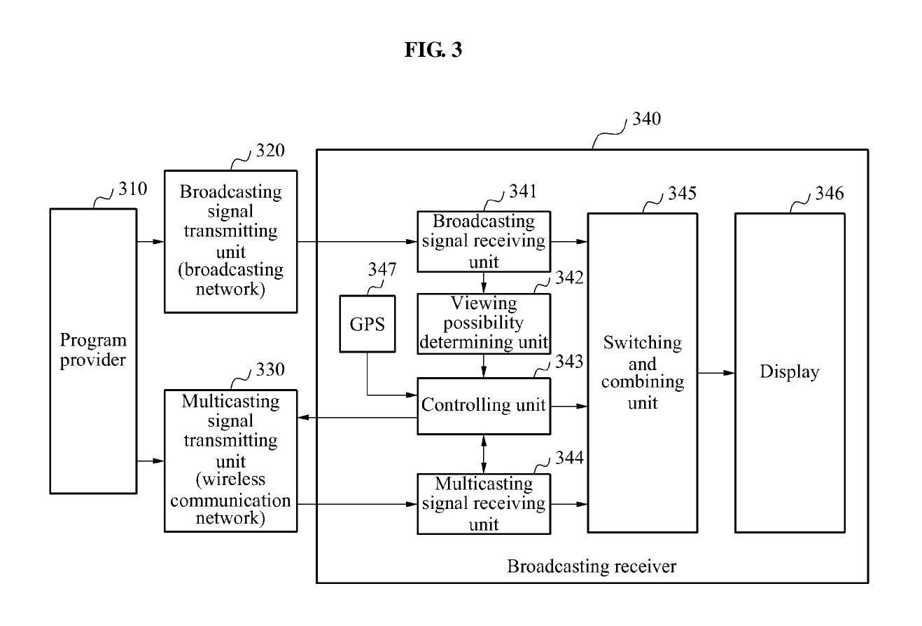

FIG. 3 is a diagram illustrating a broadcasting system according to an exemplary embodiment of the present invention.

Referring to FIG. 3, the broadcasting system includes a program provider 310, a broadcasting signal transmitting unit 320 using a broadcasting network, a multicasting signal transmitting unit 330 using a wireless communication network, and a broadcasting receiver 340.

The broadcasting receiver 340 includes a broadcasting signal receiving unit 341, a viewing possibility determining unit 342, a controlling unit 343, a multicasting signal receiving unit 344, a switching and combining unit 345, a display 346, and a global positioning system (GPS) module 347.

The broadcasting signal receiving unit 341 receives the broadcasting signal via the broadcasting network. The broadcasting network may be a wireless digital broadcasting network shown in FIG. 1, and the broadcasting signal may be provided by the program provider 310. A plurality of programs may exist, and broadcasting signals corresponding to the plurality of programs may be of different types from each other.

In addition, the viewing possibility determining unit 342 determines whether it is possible for a viewer to view the broadcasting signal. In particular, the viewing possibility determining unit 342 may determine whether it is possible for the viewer to view the broadcasting signal based on a quality of the received broadcasting signal. For example, when the broadcasting receiver 340 is included in a poor reception area in the broadcasting network, or the quality of the broadcasting signal is lower than a reference value, the broadcasting signal may be determined to be impossible to be viewed by the viewer.

Moreover, the viewing possibility determining unit 342 may estimate the quality of the broadcasting signal based on a location of the broadcasting receiver 340. That is, when the broadcasting receiver 340 stores map data, the viewing possibility determining unit 342 may predict whether the broadcasting receiver 340 will be located in the poor reception area either in the present or in the future based on the map data. Based on the prediction result, the viewing possibility determining unit 342 may determine whether it is possible for the viewer to view the broadcasting signal. Here, information associated with the location of the broadcasting receiver 340 is measured by a location sensor included in the GPS module 347.

Also, the multicasting signal receiving unit 344 receives a multicasting signal from the multicasting signal transmitting unit 330 via the wireless communication network. The multicasting signal transmitting unit 330 may receive a multicast request from the broadcasting receiver. In response to the multicast request, the multicasting signal transmitting unit 330 may identify the multicasting signal corresponding to the broadcasting signal, that is, a program received by the broadcasting receiver 340 via the broadcasting network. The identified multicasting signal is multicast to the broadcasting receiver 340.

Also, the switching and combining unit 345 combines or switches the received broadcasting signal and the multicasting signal.

Further, based on the determination result, the controlling unit 343 requests the multicasting signal transmitting unit 330 to multicast the multicasting signal, requests the multicasting signal receiving unit 344 to receive the multicasting signal, and controls the switching and combining unit 345 depending on whether the multicasting signal is received.

In particular, when it is possible for the viewer to view the broadcasting signal, the controlling unit 343 requests the multicasting signal transmitting unit 330 to multicast the multicasting signal, and requests the multicasting signal receiving unit 344 to receive the multicasting signal.

The switching and combining unit 345 may only process the broadcasting signal when only the broadcasting signal is received. However, when the broadcasting signal and the multicasting signal are both received, the switching and combining unit 345 combines the broadcasting signal and multicasting signal.

An output of the switching and combining unit 345 is provided to the display 346.

Furthermore, the controlling unit 343 may request the multicasting signal transmitting unit 330 to suspend multicasting the multicasting signal, when the multicasting signal transmitting unit 330 transitions to a state of being possible for the viewer to view the broadcasting signal from a state of being impossible for the viewer to view the broadcasting signal, that is, when a good reception of the broadcasting signal resumes.

Also, the controlling unit 343 may identify the type of the broadcasting signal and request the multicasting signal transmitting unit to multicast the multicasting signal corresponding to the type of the broadcasting signal.

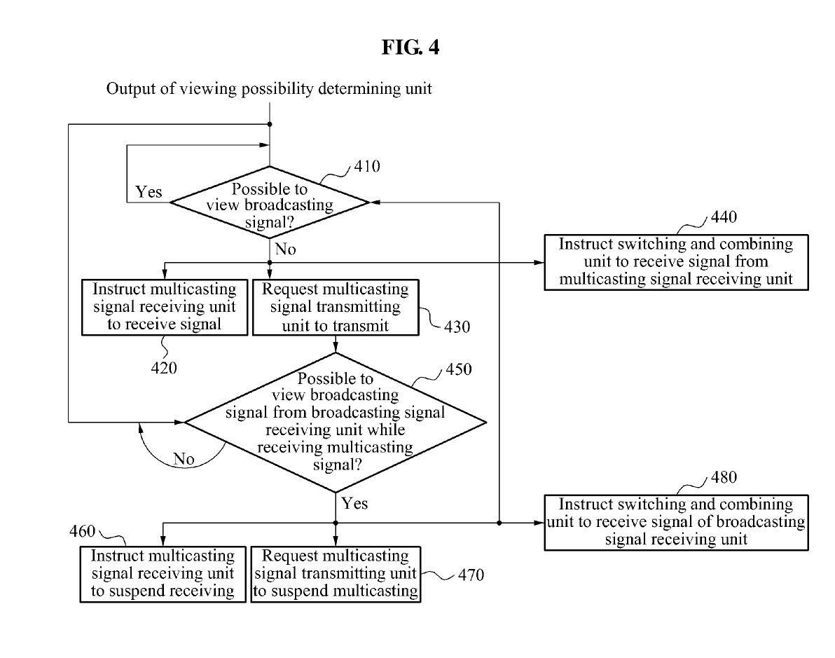

FIG. 4 is a flowchart illustrating an operational method of a controlling unit according to an exemplary embodiment of the present invention.

Referring to FIG. 4, in operation 410, the controlling unit determines whether it is possible for a viewer to view the broadcasting signal based on an output of a viewing possibility determining unit. When it is possible for the viewer to view the broadcasting signal, operation 410 is repeated. Conversely, when it is impossible for the viewer to view the broadcasting signal, the controlling unit instructs a multicasting signal receiving unit to receive a multicasting signal in operation 420, and requests a multicasting signal transmitting unit to multicast a multicasting signal in operation 430. In operation 440, the controlling unit instructs a switching and combining unit to receive a signal of the multicasting signal receiving unit. Here, the switching and combining unit may receive only the multicasting signal, or receive both the multicasting signal and the broadcasting signal.

In operation 450, the controlling unit determines whether it is possible for the viewer to view the broadcasting signal, while receiving the multicasting signal. When it is impossible for the viewer to view the broadcasting signal, operation 410 is repeated. When it is possible for the viewer to view the broadcasting signal, the controlling unit instructs the multicasting signal receiving unit to suspend receiving a signal in operation 460, and requests 470 the multicasting signal transmitting unit to suspend multicasting the signal in operation 470. In operation 480, the controlling unit instructs 480 the switching and combining unit to receive the broadcasting signal.

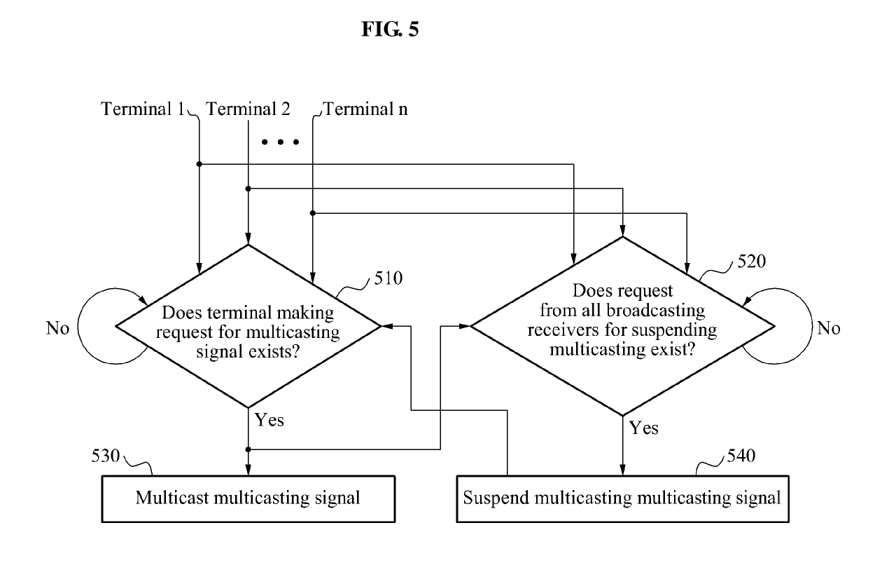

FIG. 5 is a flowchart illustrating an operational method of a multicasting signal transmitting unit according to an exemplary embodiment of the present invention.

Referring to FIG. 5, the multicasting signal transmitting unit monitors whether there is a multicast request from a plurality of n terminals, for example, a broadcasting receiver. That is, in operation 510, the multicasting signal transmitting unit determines whether a terminal making a request for the multicasting signal exists.

In operation 530, when there is the terminal making a request for the multicasting signal exists, the multicasting signal transmitting unit multicasts the multicasting signal corresponding to the broadcasting signal to the terminal. In this instance, when at least one terminal is making a request for the identical multicasting signal, the multicasting signal transmitting unit multicasts the multicasting signal using the identical logical wireless resources.

In operation 520, the multicasting signal transmitting unit monitors whether all the terminals request the multicasting signal transmitting unit to suspend multicasting the multicasting signal. When all the terminals request the multicasting signal transmitting unit to suspend multicasting the multicasting signal, the multicasting may be suspended in operation 540. When all the terminals fail to request the multicasting signal transmitting unit to suspend multicasting the multicasting signal, the multicasting may continue.

According to embodiments of the present invention, there is provided a technology of employing a wireless communication network such as a wireless local area network (LAN), a mobile communication network, and the like to continuously receive a broadcasting signal despite being in a poor reception area while a broadcasting receiver receives the broadcasting signal via a broadcasting network.

Also, according to embodiments of the present invention, it is possible to transmit/receive a multicasting signal, using an infrastructure of the wireless communication network in the poor reception area, and efficiently uses a multicasting function, thereby reducing resources of the wireless communication network when a number of users are simultaneously connected.

The above-described exemplary embodiments of the present invention may be recorded in computer-readable media including program instructions to implement various to operations embodied by a computer. The media may also include, alone or in combination with the program instructions, data files, data structures, and the like. The media and program instructions may be those specially designed and constructed for the purposes of the present invention, or they may be of the kind well-known and available to those having skill in the computer software arts. Examples of computer-readable media include magnetic media such as hard disks, floppy disks, and magnetic tape; optical media such as CD ROM discs and DVDs; magneto-optical media such as floptical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention, or vice versa.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A broadcasting receiver, comprising:
a broadcasting signal receiving unit to receive a broadcasting signal via a broadcasting network;
a viewing possibility determining unit to determine whether it is possible for a viewer to view the broadcasting signal;
a multicasting signal receiving unit to receive a multicasting signal via a wireless communication network;
a switching and combining unit to combine or switch the received broadcasting signal and the multicasting signal; and
a controlling unit to request a multicasting signal transmitting unit to multicast the multicasting signal based on the determination result, to request the multicasting signal receiving unit to receive the multicasting signal, and to control the switching and combining unit depending on whether the multicasting signal is received.

2. The broadcasting receiver of claim 1, wherein the viewing possibility determining unit determines whether it is possible for the viewer to view the broadcasting signal based on a quality of the received broadcasting signal.

3. The broadcasting receiver of claim 1, wherein the controlling unit, when it is impossible for the viewer to view the broadcasting signal, requests the multicasting signal transmitting unit to multicast the multicasting signal, requests the multicasting signal receiving unit to receive the multicasting signal, and controls the switching and combining unit depending on whether the multicasting signal is received.

4. The broadcasting receiver of claim 1, further comprising:
a display to display an output of the switching and combining unit.

5. The broadcasting receiver of claim 1, wherein the controlling unit identifies a type of the broadcasting signal, and requests the multicasting signal transmitting unit to multicast the multicasting signal corresponding to the type of the broadcasting signal.

6. The broadcasting receiver of claim 1, wherein the controlling unit, when it transits to a state of being possible for the viewer to view the broadcasting signal from a state of being impossible for the viewer to view the broadcasting signal, requests the multicasting signal transmitting unit to suspend multicasting the multicasting signal.

7. The broadcasting receiver of claim 1, wherein the viewing possibility determining unit determines whether it is possible for the viewer to view the broadcasting signal based on pre-stored map data and a location of the broadcasting receiver.

8. The broadcasting receiver of claim 7, wherein the controlling unit requests in advance the multicasting signal transmitting unit to multicast the multicasting signal based on a future location of the broadcasting receiver.

9. A method of receiving a broadcasting signal, the method comprising:
receiving a broadcasting signal via a broadcasting network;
determining whether it is possible for a viewer to view the broadcasting signal;
requesting a multicasting signal transmitting unit to multicast a multicasting signal based on the determination result;
multicasting to receive the multicasting signal via a wireless communication network; and
combining or switching the received broadcasting signal and the multicasting signal depending on whether the multicasting signal is received.

10. The method of claim 9, wherein the determining comprises determining whether it is possible for the viewer to view the broadcasting signal based on a quality of the received broadcasting signal.

11. The method of claim 9, further comprising:
requesting the multicasting signal transmitting unit to suspend multicasting the multicasting signal, when the multicasting signal transmitting unit transitions to a state of being possible for the viewer to view the broadcasting signal from a state of being impossible for the viewer to view the broadcasting signal.

12. The method of claim 9, further comprising:
identifying a type of the broadcasting signal,
wherein the requesting comprises requesting the multicasting signal transmitting unit to multicast a multicasting signal corresponding to the type of the broadcasting signal.

13. A method of multicasting a multicasting signal corresponding to a broadcasting signal via a wireless communication network, the method comprising:
receiving a multicast request from at least one broadcasting receiver equipped to receive a signal via a broadcasting network and the wireless communication network;
identifying the multicasting signal corresponding to the broadcasting signal received by the at least one broadcasting receiver via the broadcasting network in response to the multicast request;
multicasting the multicast signal to the at least one broadcasting receiver;
monitoring whether all the broadcasting receivers request the multicasting signal transmitting unit to suspend multicasting the multicasting signal; and
suspending multicasting the multicasting signal when all the broadcasting receivers request the multicasting signal transmitting unit to suspend multicasting the multicasting signal.

14. The method of claim 13, wherein the multicasting comprises multicasting the multicasting signal using identical logical wireless resources.
